(19) United States
(12) Patent Application Publication
(10) Pub. No.: US 2004/0102564 A1
(43) Pub. Date: May 27, 2004

(54) Method for producing thermoplastic molding materials containing rubber

(76) Inventors: Norbert Guntherberg, Speyer (DE); Bernhard Czauderna, Hirschberg (DE); Hartmut Heinen, Koln (DE)

Correspondence Address: KEIL & WEINKAUF, 1350 CONNECTICUT AVENUE, N.W., WASHINGTON, DC, 20036, US

(21) Appl. No.: 10/416,469

(22) PCT Filed: Nov. 21, 2001
(86) PCT No.: PCT/EP01/13487

(30) Foreign Application Priority Data
Nov. 22, 2000 (DE) 10058133.1

(51) Int. Cl. C08J 3/00

(52) U.S. Cl. 524/500; 524/501

(57) ABSTRACT

Process for preparing rubber-containing thermoplastic molding compositions, by using polymerization to prepare at least one elastomeric polymer A and at least one thermoplastic polymer B, and mixing these with one another, the elastomeric polymer A being present in dispersed form in an aqueous phase after the polymerization, which comprises adding at least one pH-buffer system to the aqueous phase after the polymerization of component A has ended.

The invention relates to a process for preparing rubber-containing thermoplastic molding compositions, by using polymerization to prepare at least one elastomeric polymer A and at least one thermoplastic polymer B, and mixing these with one another, the elastomeric polymer A being present in dispersed form in an aqueous phase after the polymerization.

The invention further relates to the rubber-containing thermoplastic molding compositions obtainable by this process, to their use for producing moldings, films, fibers, or foams, and also to the resultant moldings, films, fibers, and foams. Finally, the invention relates to a process for reducing mold deposit during the production of injection moldings from rubber-containing thermoplastic molding compositions.

Injection molding and extrusion are processes used particularly frequently for processing thermoplastic molding compositions impact-modified by addition of rubbers. Use is also frequently made of both of these steps one after the other, pellets being prepared by extrusion and these then being used to produce moldings by injection molding. A factor common to the two processes is that polymers are melted and the polymer melt is discharged through dies under pressure. The high temperatures or pressures required here can bring about some decomposition of the molding composition. The decomposition products deposit as mold deposit on the injection molds or extruder components used. Other causes of mold deposit are bleed-out (migration) of constituents of the molding compositions, for example unconverted starting monomers or their oligomers and polymers, and polymerization auxiliaries and lubricants.

Mold deposit accumulates not only in the mold itself but also on the dies and vents, disrupting the process of molding by injection molding (poorer surface quality of injection-molded parts) or extrusion. Deposits of this type occur in particular on the injection moldings themselves, reducing their quality. They cause problems due to their different color, and are often oily or mat, and lead to inhomogeneous and non-uniform surfaces. The deposits also hinder or prevent processes such as the printing, adhesive bonding, or electroplating of the moldings.

To remove mold deposit, the production process has to be interrupted after a certain period of extrusion or number of injection molding cycles, for mechanical cleaning of the mold, the dies and the vents. This shutdown of the machinery (“cleaning stop”) causes loss of production, and the time-consuming cleaning process also requires employee time. Finally, a certain proportion of the moldings have to be rejected as scrap.

It is known from the earlier application DE file number 19962570.0, filed but not published before the date of the present application, that concomitant use may be made of a magnesium oxide with a citric acid value <1500 sec during extrusion or injection molding in order to reduce mold deposit. The resultant reduction in mold deposit is not satisfactory for every application.

DE-A 44 08 213 discloses ABS molding compositions with pale intrinsic color which comprise small amounts of alkali metal hydrogencarbonates or alkali metal carbonates, or small amounts of alkaline earth metal oxides or alkaline earth metal carbonates. The metal compounds mentioned are mixed dry with polybutadiene graft rubber, styrene-acrylonitrile copolymer, and conventional additives in a kneader at from 180 to 200° C. The metal compounds are therefore not added to an aqueous phase, but to a dry polymer. The specification makes no mention of a reduction in mold deposit.

It is an object of the present invention to eliminate the disadvantages described. The process to be provided should give rubber-containing thermoplastic molding compositions which give a marked reduction in mold deposit. In particular, the reduction in mold deposit achievable by the process should be more pronounced than that from the described addition of magnesium oxide.

We have found that this object is achieved by means of the process described at the outset. It comprises adding at least one pH buffer system to the aqueous phase once the polymerization of component A has ended.

The rubber-containing thermoplastic molding compositions obtainable by this process have also been found, as has their use for producing moldings, films, fibers, or foams, and also the resultant moldings, films, fibers, and foams. Finally, a process has been found for reducing mold deposit during the production of injection-molded parts from rubber-containing thermoplastic molding compositions, which comprises using, for injection molding, the abovementioned rubber-containing thermoplastic molding compositions.

Elastomeric Polymer A

Suitable elastomeric polymers A are any of the polymers which have elastomeric properties. These elastomeric polymers (referred to below by the abbreviated term rubbers) preferably have a glass transition temperature Tg of 0° C., or below, determined to DIN 53765 by differential scanning calorimetry (DSC), heating rate 20 K/min, flushing gas nitrogen, determination of mid-point Tg (the temperature at which the glass transition has reached half of its height) from the second run.

The polymer A is preferably prepared in the presence of water, giving an aqueous polymer dispersion. If this polymer A is prepared in the absence of water, a conventional method has to be used to prepare a dispersion from the polymer A and water.

The elastomeric polymers A are preferably those selected from the following materials prepared in an aqueous phase or present in an aqueous phase:

diene rubbers, e.g. those based on conjugated dienes, such as butadiene, isoprene, norbornene, chloroprene,

acrylate rubbers, e.g. those based on alkyl (meth)acrylates, such as n-butyl acrylate or 2-ethylhexyl acrylate. The acrylate rubbers generally contain crosslinking monomers, such as allyl (meth)acrylates or dihydrodicyclopentadienyl acrylate,

rubbers based on ethylene and propylene (EPM rubbers) or on these together with a diene, such as ethylidenenorbornene or dicyclopentadiene (EPDM rubbers),

silicone rubbers (siloxane rubbers), e.g. those based on highly crosslinked silicone oils, which in turn are composed of siloxanes, e.g. methylsiloxanes; the crosslinkers used comprising peroxides or other conventional crosslinkers; an example of an underlying polymer for the silicone rubbers being dimethylpolysiloxane,

and mixtures of these. Other elastomeric polymers A are also suitable as long as they are present in an aqueous phase, i.e. as a dispersion.

In one preferred embodiment, the elastomeric polymer A is a graft polymer comprising at least one elastomeric graft base with a glass transition temperature Tg of 0° C. or below and at least one hard graft with a glass transition temperature Tg above 25° C. Tg is determined as described above.

This embodiment is described in more detail below.

The graft polymers preferably contain, based on the graft polymer,

a1) from 30 to 95% by weight, preferably from 40 to 90% by weight, and particularly preferably from 40 to 85% by weight, of an elastomeric graft base made from, based on a1)

a11)from 50 to 100% by weight, preferably from 60 to 100% by weight, and particularly preferably from 70 to 100% by weight, of a C₁-C₁₀-alkyl ester of acrylic acid,

a12) from 0 to 10% by weight, preferably from 0 to 5% by weight, and particularly preferably from 0 to 2% by weight, of a polyfunctional crosslinking monomer, and

a13)from 0 to 40% by weight, preferably from 0 to 30% by weight, and particularly preferably from 0 to 20% by weight, of one or more other monoethylenically unsaturated monomers,

or made from

a11*) from 50 to 100% by weight, preferably from 60 to 100% by weight, and particularly preferably from 65 to 100% by weight, of a diene having conjugated double bonds, and

a12*) from 0 to 50% by weight, preferably from 0 to 40% by weight, and particularly preferably from 0 to 35% by weight, of one or more monoethylenically unsaturated monomers, and

a2) from 5 to 70% by weight, preferably from 10 to 60% by weight, and particularly preferably from 15 to 60% by weight, of a graft made from, based on a2),

a21) from 50 to 100% by weight, preferably from 60 to 100% by weight, and particularly preferably from 65 to 100% by weight, of a styrene compound of the formula I

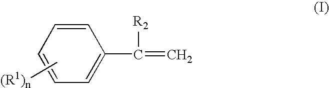

where R¹ and R² are hydrogen or C₁-C₈-alkyl, and n is 0, 1, 2, or 3,

or of a C₁-C₈-alkyl (meth)acrylate,

or of a mixture of the styrene compound and the C₁-C₈-alkyl (meth)acrylate,

a22) from 0 to 40% by weight, preferably from 0 to 38% by weight, and particularly preferably from 0 to 35% by weight, of acrylonitrile, or methacrylonitrile, or a mixture of these, and

a23) from 0 to 40% by weight, preferably from 0 to 30% by weight, and particularly preferably from 0 to 20% by weight, of one or more other monoethylenically unsaturated monomers.

Particularly suitable C₁-C₁₀-alkyl esters of acrylic acid, component all), are ethyl acrylate, 2-ethylhexyl acrylate and n-butyl acrylate. 2-Ethylhexyl acrylate and n-butyl acrylate are preferred, and n-butyl acrylate is very particularly preferred. It is also possible to use mixtures of various alkyl acrylates which differ in their alkyl radical.

Crosslinking monomers a12) are bi- or polyfunctional comonomers having at least two olefinic double bonds, for example butadiene and isoprene, divinyl esters of dicarboxylic acids, such as succinic acid and adipic acid, diallyl and divinyl ethers of bifunctional alcohols, such as those of ethylene glycol and of 1,4-butanediol, diesters of acrylic acid and of methacrylic acid with the bifunctional alcohols mentioned, 1,4-divinylbenzene, and triallyl cyanurate. Particular preference is given to tricyclodecenyl acrylate (see DE-A 12 60 135) also known as dihydrodicyclopentadienyl acrylate, and also to the allyl esters of acrylic acid and of methacrylic acid.

Depending on the nature of the molding compositions to be prepared, and in particular depending on the properties desired in the molding compositions, crosslinking monomers a12) may be present or absent in the molding compositions.

If crosslinking monomers a12) are present in the molding compositions, the amounts are from 0.01 to 10% by weight, preferably from 0.3 to 8% by weight, and particularly preferably from 1 to 5% by weight, based on a1).

Examples of the other monoethylenically unsaturated monomers a13) which may be present in the graft core a1), with concomitant reduction in the amounts of monomers a11) and a12) are:

vinylaromatic monomers, such as styrene, and styrene derivatives of the above formula I;

acrylonitrile, methacrylonitrile;

C₁-C₄-alkyl esters of methacrylic acid, such as methyl methacrylate, and also the glycidyl esters, glycidyl acrylate and glycidyl methacrylate;

N-substituted maleimides, such as N-methyl-, N-phenyl- and N-cyclohexylmaleimide;

acrylic acid, methacrylic acid, and also dicarboxylic acids, such as maleic acid, fumaric acid and itaconic acid, and also anhydrides of these, such as maleic anhydride;

monomers having nitrogen functional groups, for example dimethylaminoethyl acrylate, diethylaminoethyl acrylate, vinylimidazole, vinylpyrrolidone, vinylcaprolactam, vinylcarbazole, vinylaniline, acrylamide and methacrylamide;

aromatic and araliphatic esters of acrylic acid and of methacrylic acid, such as phenyl acrylate, phenyl methacrylate, benzyl acrylate, benzyl methacrylate, 2-phenylethyl acrylate, 2-phenylethyl methacrylate, 2-phenoxyethyl acrylate and 2-phenoxyethyl methacrylate;

unsaturated ethers, such as vinyl methyl ether, and also mixtures of these monomers.

Preferred monomers a13) are styrene, acrylonitrile, methyl methacrylate, glycidyl acrylate, glycidyl methacrylate, acrylamide and methacrylamide.

It is also possible for the graft base a1) to have been built up from the monomers a11*) and a12*), instead of the graft base monomers a11) to a13).

Possible dienes a11*) having conjugated double bonds are butadiene, isoprene, norbornene, and halogen-substituted derivatives of these, such as chloroprene. Butadiene and isoprene are preferred, in particular butadiene.

Other monoethylenically unsaturated monomers a12*) which may be used concomitantly are those mentioned above for the monomers a13).

Preferred monomers a12*) are styrene, acrylonitrile, methyl methacrylate, glycidyl acrylate, glycidyl methacrylate, acrylamide and methacrylamide. Particularly preferred monomer a12*) is styrene.

The graft core a1) may also have been built up from a mixture of the monomers a11) to a13), and a11*) to a12*).

The two embodiments of the graft core made from

monomers a11) to a13)=acrylate rubber, and

monomers a11* to a12*)=diene rubber, are equally preferred.

If the graft core a1) contains the acrylate rubber monomers a11) to a13), then polymerization of the graft base a2) and blending with a hard thermoplastic polymer B made from polystyrene-acrylonitrile (SAN), known as the hard matrix, gives molding compositions of ASA type. If the graft core contains the diene rubber monomers a11*) to a12*), then grafting and blending with the SAN hard matrix gives molding compositions of ABS type.

The graft a2) contains, as component a21), either the styrene compound of the formula I or a C₁-C₈-alkyl (meth)acrylate, or a mixture of the styrene compound and the C₁-C₈-alkyl (meth)acrylate. The preferred styrene compound used comprises styrene, α-methylstyrene, p-methylstyrene, or a mixture of these. Styrene is particularly preferred. The C₁-C₈-alkyl (meth)acrylate used preferably comprises methyl methacrylate (MMA) or a mixture of MMA with methyl, ethyl, propyl, or butyl acrylate.

If the graft core contains the acrylate-rubber monomers all) to a13) or the diene-rubber monomers a11*) to a12*), and the graft a2) contains, as monomers a21), C₁-C₈-alkyl (meth)acrylates, such as MMA, and, where appropriate, styrene, blending with polymethyl methacrylate (PMMA) gives impact-modified PMMA molding compositions.

In relation to the monomers a21) and a23), reference should be made to the remarks relating to component a13). The graft shell a2) may therefore comprise other monomers a22), or a23), or mixtures of these, with concomitant reduction in the monomers a21). It is preferable for the graft shell a2) to have been built up from polystyrene, from copolymers of styrene (or α-methylstyrene) and acrylonitrile, or from copolymers of styrene and methyl methacrylate.

The graft a2) may be prepared under the conditions used for preparing the graft base a1), and may be prepared in one or more steps. The monomers a21), a22) and a23) here may be added individually or in a mixture with one another. The ratio of monomers in the mixture may be constant over time or may be graduated. Combinations of these procedures are also possible. For example, styrene on its own may first be polymerized onto the graft base a1), followed by a mixture of styrene and acrylonitrile. The overall composition remains unaffected by the embodiments mentioned of the process.

Details of the preparation of graft polymers based on dienes (e.g. butadiene on its own or butadiene with styrene comonomer) in an aqueous phase can be found in WO-A 99/01489.

Other suitable graft polymers have two or more “soft” stages S and/or “hard” stages H (i.e. what is known as multishell morphology), having for example from the inside to the outside the structure a1)-a2)-a1)-a2)=SHSH or a2)-a1)-a2)=HSH, or a2)-a1)-a2)-a2)=HSHH, especially for relatively large particles. In any of the morphologies mentioned here the two or more stages a1) present may be identical or differ in the nature and/or amount of their monomers. The same applies to any two or more of the stages a2) present.

To the extent that ungrafted polymers are produced from the monomers a2) during the grafting, any amounts of these, which are generally below 10% by weight of a2), are counted with the weight of graft polymer A and not with the hard matrix B.

The graft polymers A may be prepared in various ways, preferably in emulsion, in microemulsion, in miniemulsion, in suspension, in microsuspension, or in minisuspension, i.e. in the presence of an aqueous phase. However, A may also be prepared by precipitation polymerization, in bulk or in solution. All of the polymerization processes may be carried out continuously or batchwise.

In the preferred emulsion polymerization and variants thereof (microemulsion, miniemulsion) the monomers are emulsified in water, with concomitant use of emulsifiers. The emulsifiers suitable for stabilizing the emulsion are soap-like auxiliaries which encapsulate the monomer droplets and thus prevent them from coalescing.

Suitable emulsifiers are the anionic, cationic or neutral (nonionic) emulsifiers known to the person skilled in the art. Examples of anionic emulsifiers are alkali metal salts of higher fatty acids having from 10 to 30 carbon atoms, such as palmitic, stearic or oleic acid, alkali metal salts of sulfonic acids having, for example, from 10 to 16 carbon atoms, in particular sodium salts of alkyl- or alkylarylsulfonic acids, alkali metal salts of half-esters of phthalic acid, and alkali metal salts of resin acids, such as abietic acid. Examples of cationic emulsifiers are salts of long-chain amines, in particular unsaturated amines, having from 12-18 carbon atoms, or quaternary ammonium compounds with relatively long-chain olefinic or paraffinic radicals (i.e. salts of quaternized fatty amines). Examples of neutral emulsifiers are ethoxylated fatty alcohols, ethoxylated fatty acids, and ethoxylated phenols, and fatty acid esters of polyhydric alcohols, such as pentaerythritol or sorbitol.

Initiators used for the emulsion polymerization are preferably those which have low solubility in the monomer but good solubility in water. It is therefore preferable to use peroxosulfates, such as those of potassium, sodium or ammonium, or else redox systems, in particular those based on hydroperoxides, for example cumene hydroperoxide, dicumyl peroxide, benzoyl peroxide or lauroyl peroxide.

If redox systems are used, concomitant use is made of water-soluble metal compounds whose metal cations can easily change their oxidation state, e.g. iron sulfate hydrate. Concomitant use is usually also made of complex-formers, such as sodium pyrophosphate or ethylenediamine tetraacetic acid, which prevent precipitation of low-solubility metal compounds during the polymerization. Reducing agents generally used in the case of redox systems are organic compounds, such as dextrose, glucose and/or sulfoxylates.

Other additives which may be used during the polymerization are buffer substances (referred to below by the abbreviated term buffers II), such as Na₂HPO₄/NaH₂PO₄ or sodium citrate/citric acid, these being used in order to set an essentially constant pH. These buffers II are used during the polymerization of A and are not to be confused with the pH buffers (buffers I, see further below) which according to the invention are used once the polymerization of components A and B has ended, prior to or during the mixing of the finished polymers A and B. The buffers I and II may be chemically identical or different.

Concomitant use may also be made of molecular-weight regulators, for example mercaptans, such as tert-dodecyl mercaptan, or ethylhexyl thioglycolate. Like the emulsifiers and initiators or redox systems, these other additives may be added continuously or batchwise at the start of and/or during the preparation of the emulsion, and/or during the polymerization.

The exact polymerization conditions, in particular the nature, amount, and method of addition of the emulsifier, and of the other polymerization auxiliaries, are preferably selected in such a way as to give the resultant latex of the graft polymer a median particle size, defined via the d₅₀ of the particle size distribution, of from 50 to 1000 nm, preferably from 50 to 800 nm, and particularly preferably from 80 to 700 nm.

The particle size distribution may be monomodal or bimodal, for example. It is preferable to achieve a bimodal particle size distribution by (partial) agglomeration of the polymer particles. An example of a procedure for this purpose is as follows: the monomers a1) which build up the core are polymerized until the conversion is usually at least 90%, preferably above 95%, based on the monomers used. The resultant rubber latex generally has a median particle size d₅₀ of not more than 200 nm and a narrow particle size distribution (the system is approximately monodisperse).

In the second stage, the rubber latex is agglomerated, generally by adding a dispersion of an acrylate polymer. It is preferable to use dispersions of copolymers of C₁-C₄-alkyl esters of acrylic acid, preferably of ethyl acrylate, with from 0.1 to 10% by weight of monomers forming polar polymers, e.g. acrylic acid, methacrylic acid, acrylamide or methacrylamide, N-methylolmethacrylamide or N-vinylpyrrolidone. Particular preference is given to a copolymer made from 94-96% of ethyl acrylate and 4-6% of methacrylamide. The concentration of the acrylate polymers in the dispersion used for the agglomeration should generally be from 3 to 40% by weight. Under the conditions mentioned, only some of the rubber particles are agglomerated, and a bimodal distribution is therefore produced. The proportion of the particles present in the agglomerated state may be controlled via the type, amount, and method of addition of the agglomerating dispersion used. It is usually from 5 to 99%, in particular from 10 to 95%.

The agglomeration process is followed by the polymerization, described above, of the graft a2).

The emulsion polymerization reaction is generally undertaken under conditions of slow or moderate agitation.

The work-up of the dispersion of the graft polymer A takes place in a known manner. The graft polymer A is usually first precipitated from the dispersion, for example by adding precipitant salt solutions (such as calcium chloride, magnesium sulfate, alum) or acids (such as acetic acid, hydrochloric acid, or sulfuric acid), or else by freezing (freeze-coagulation). The aqueous phase may be removed in a conventional manner, for example by screening, filtration, decanting, or centrifuging. This removal of the water of the dispersion generally gives moist graft polymers A with a residual water content of up to 60%, based on A, and this residual water may be either adhering externally to the graft polymer, for example, or else enclosed therein.

The graft polymer may then be dried further in a known manner if necessary, e.g. using warm air or by means of a fluidized-bed dryer.

It is also possible for the dispersion to be worked up by spray drying.

The microemulsion polymerization differs from normal emulsion polymerization especially in that high shear forces are used to prepare an emulsion from the monomers with water and with the emulsifiers. The homogenizers used for this are known to the person skilled in the art. The miniemulsion polymerization differs from normal emulsion polymerization and from microemulsion polymerization especially in that the particles are usually stabilized with respect to coalescence, by way of a combination of ionic emulsifiers and coemulsifiers. In miniemulsion, the mixture made from monomers, water, emulsifiers and coemulsifiers is exposed to high shear forces which result in intimate mixing of the components. Polymerization then follows. The usual coemulsifiers used are long-chain alkanes, such as hexadecane, or long-chain alcohols, such as hexadecanol (cetyl alcohol) or dodecanol.

In suspension polymerization, which is also preferred, and its variants (microsuspension, minisuspension), the monomers are suspended in water, and to this end concomitant use is made of protective colloids. Suitable protective colloids are cellulose derivatives, such as carboxymethylcellulose and hydroxymethylcellulose, poly-N-vinylpyrrolidone, polyvinyl alcohol and polyethylene oxide, anionic polymers, such as polyacrylic acid and copolymers thereof, and cationic polymers, such as poly-N-vinylimidazole. The amount of these protective colloids is preferably from 0.1 to 5% by weight, based on the total weight of the emulsion. It is preferable to use one or more polyvinyl alcohols as protective colloid, in particular those with a degree of hydrolysis below 96 mol %.

In addition to the protective colloids, concomitant use may be made of colloidal silica, generally at a concentration of from 0.2 to 5% by weight, based on the amount of the dispersion.

For the suspension polymerization, preference is given to initiators with a half-life time of one hour at temperatures of from 40 to 150° C. and with marked solubility in the monomers but poor solubility in water. The initiators RI used are therefore organic peroxides, organic hydroperoxides, azo compounds, and/or compounds having single carbon-carbon bonds. Monomers which polymerize spontaneously at elevated temperatures may likewise be used as free-radical polymerization initiators. It is also possible to use mixtures of the initiators RI mentioned. Preferred peroxides are those with hydrophobic properties. Dilauroyl peroxide and dibenzoyl peroxide are very particularly preferred. Preferred azo compounds are 2,2′-azobis(2-methylbutyronitrile) and 2,2′-azobis(isobutyronitrile). Preferred compounds having labile carbon-carbon bonds are 3,4-dimethyl-3,4-diphenylhexane and 2,3-dimethyl-2,3-diphenylbutane.

The polymerization reaction is generally undertaken with slow or moderate agitation.

In relation to the removal of the water from the rubber, what has been said above for emulsion polymerization is applicable.

The microsuspension polymerization differs from normal suspension polymerization mainly in that high shear forces are used to prepare a fine-particle suspension. Details were described above under microemulsion polymerization. Minisuspension polymerization differs from normal suspension polymerization and from microsuspension polymerization mainly in that the particle sizes are generally between those for suspension polymerization and those for microsuspension polymerization.

If the process carried out is precipitation polymerization, as is also possible, the monomers used are soluble in the continuous phase (e.g. solvent or solvent mixture), but the resultant polymers are insoluble or have only limited solubility and therefore precipitate during the polymerization. Bulk polymerization processes in which the resultant polymer is insoluble in the monomer and therefore precipitates are also possible. Depending on the reaction medium, use may be made of the initiators described for emulsion or suspension polymerization. Thermal initiation may also be used.

If the process carried out is bulk polymerization, as is possible, the monomers are polymerized without adding any reaction medium, using the monomer-soluble initiators mentioned, i.e. the monomers are the reaction medium. Thermal initiation may also be used.

The solution polymerization, which may also be used, differs from the bulk polymerization mainly in that concomitant use is made of an organic solvent, such as cyclohexane, ethylbenzene, toluene or dimethyl sulfoxide to dilute the monomers. It is also possible to use the initiators mentioned, or thermal initiation may be used.

The process for preparing the graft polymers may also be carried out as a combined process in which at least two of the polymerization processes described above are combined with one another. Particular mention should be made here of bulk/solution, solution/precipitation, bulk/suspension and bulk/emulsion, in each case beginning with the process mentioned first and finishing with the process mentioned second.

Polymers prepared in bulk or in solution, or in some other way in the absence of water, have to be dispersed in water for the process of the invention. This takes place by way of conventional dispersing processes, and concomitant use may be made here of conventional auxiliaries for preparing and stabilizing the polymer dispersion.

Thermoplastic Polymer B

Any polymer with thermoplastic properties is suitable as thermoplastic polymer B. Polymers of this type are described by way of example in Kunststoff-Taschenbuch, Ed. Saechtling, 25 th Edn., Hanser-Verlag Munich 1992, in particular Section 4, and Kunststoff-Handbuch, Ed. G. Becker and D. Braun, volumes 1-11, Hanser-Verlag Munich 1966-1996. References are also mentioned in Kunststoff-Taschenbuch by Saechtling.

Preference is given to polymers B which are compatible or at least partially compatible with the graft of the graft polymer A.

In cases where polymers are incompatible or have poor compatibility, concomitant use may be made of the known compatibilizers.

Some preferred polymers B are described in more detail below.

1. Vinylaromatic polymers and polymers based on methyl methacrylate.

The weight-average molecular weight of these polymers, which are known per se and available commercially, is generally in the range from 1500 to 2,000,000, preferably in the range from 70,000 to 1,000,000.

Preferred vinylaromatic or MMA-based thermoplastic polymers B are obtained by polymerizing a monomer mixture made from, based on B),

b1) from 50 to 100% by weight, preferably from 60 to 95% by weight, and particularly preferably from 60 to 90% by weight, of a styrene compound of the abovementioned formula I,

or of a C₁-C₈-alkylester of acrylic acid or (preferably) of methacrylic acid,

or of mixtures of the styrene compound and the C₁-C₈-alkyl (meth)acrylate,

b2) from 0 to 40% by weight, preferably from 5 to 38% by weight, of acrylonitrile or methacrylonitrile, or a mixture of these, and

b3) from 0 to 40% by weight, preferably from 0 to 30% by weight, of one or more monoethylenically unsaturated monomers other than b2).

The vinylaromatic component B preferably has a glass transition temperature T_{g} of 50° C. or above. The vinylaromatic polymer B is therefore a hard polymer.

The styrene compound of the general formula (I) (component b1)) used is preferably styrene, α-methylstyrene, or else other C₁-C₈-alkyl-ring-alkylated styrenes, such as p-methylstyrene or tert-butylstyrene. Styrene is particularly preferred. It is also possible to use mixtures of the styrenes mentioned, in particular of styrene and α-methylstyrene.

Instead of the styrene compounds, or mixed with these, it is possible to use C₁-C₈-alkyl (meth)acrylates, particularly those derived from methanol, ethanol, n-propanol, isopropanol, sec-butanol, tert-butanol, isobutanol, pentanol, hexanol, heptanol, octanol, 2-ethylhexanol, or n-butanol. Preference is given to methacrylates. Methyl methacrylate (MMA) is particularly preferred.

A preferred MMA-based component B is either an MMA homopolymer (100% by weight of MMA) or an MMA copolymer made from at least 60% by weight, preferably at least 80% by weight, and in particular at least 90% by weight, of MMA and correspondingly up to 40% by weight, preferably up to 20% by weight, and in particular up to 10% by weight, of comonomers, in particular alkyl acrylates. Suitable alkyl acrylates are acrylates having from 1 to 8 carbon atoms in the alkyl radical, for example methyl, ethyl, propyl, n-butyl, n-pentyl, n-hexyl, n-heptyl, n-octyl, or 2-ethylhexyl acrylate, or a mixture of these. Methyl acrylate is particularly preferred as alkyl acrylate comonomer. The MMA copolymers mentioned preferably have a weight-average molar mass M_{w} above 50,000 g/mol, in particular above 75,000 g/mol, and very particularly preferably above 100,000 g/mol.

Component B may also contain one or more other monoethylenically unsaturated monomers b3) with concomitant reduction in the amounts of monomers b1) and b2), the monomers b3) varying the mechanical and thermal properties of B within a certain range. Examples which may be mentioned of comonomers of this type are:

N-substituted maleimides, such as N-methyl-, N-phenyl- and N-cyclohexylmaleimide;

acrylic acid, methacrylic acid, and dicarboxylic acids, such as maleic acid, fumaric acid, and itaconic acid, and also anhydrides of these, such as maleic anhydride;

nitrogen-functional monomers, such as dimethylaminoethyl acrylate, diethylaminoethyl acrylate, vinylimidazole, vinylpyrrolidone, vinylcaprolactam, vinylcarbazole, vinylaniline, acrylamide, and methacrylamide;

aromatic and araliphatic esters of acrylic acid or methacrylic acid, for example phenyl acrylate, phenyl methacrylate, benzyl acrylate, benzylmethacrylate, 2-phenylethyl acrylate, 2-phenylethyl methacrylate, 2-phenoxyethyl acrylate, and 2-phenoxyethyl methacrylate;

unsaturated ethers, such as vinyl methyl ether,

and also mixtures of these monomers.

Examples of preferred components B are polystyrene and copolymers made from styrene and/or α-methylstyrene and from one or more of the other monomers mentioned under b1) to b3). Preference is given here to methyl methacrylate, N-phenylmaleimide, maleic anhydride, and acrylonitrile, particularly preferably methyl methacrylate and acrylonitrile. Another preferred component B is polymethyl methacrylate (PMMA).

Examples which may be mentioned of preferred components B are:

B/1: polystyrene,

B/2: copolymer of styrene and acrylonitrile,

B/3: copolymer of a-methylstyrene and acrylonitrile,

B/4: copolymer of styrene and methyl methacrylate,

B/5: PMMA,

B/6: copolymer of MMA and methyl acrylate,

B/7: copolymer of styrene and at least one of the monomers maleic anhydride, acrylonitrile, and partially or completely imidated maleic anhydride.

The proportion of styrene or α-methylstyrene, or the proportion of the entirety of styrene and α-methylstyrene is particularly preferably at least 40% by weight, in particular at least 60% by weight, based on component B.

If, as is preferred, component B comprises styrene and acrylonitrile, the result is the known and commercially available SAN copolymers. They generally have a viscosity number VN (determined to DIN 53 726 at 25° C., 0.5% by weight in dimethylformamide) of from 40 to 160 ml/g, corresponding to an average molecular weight of from about 40,000 to 2,000,000 (weight-average).

The polymers B mentioned may be obtained in a known manner, e.g. by bulk, solution, suspension, precipitation, or emulsion polymerization. Details of these processes are described in Kunststoffhandbuch, Ed. Vieweg and Daumiller, Carl-Hanser-Verlag Munich,Vol. 1 (1973), pp. 37-42 and Vol. 5 (1969), pp. 118-130, in Ullmanns Encyklopadie der technischen Chemie, 4 th Edn., Verlag Chemie Weinheim, Vol. 19, pp. 107-158 “Polymerisationstechnik”, and also in the case of MMA homo- and copolymers in Kunststoffhandbuch, Ed. Vieweg/Esser, Vol. 9 “Polymethacrylate”, Carl-Hanser-Verlag Munich 1975.

2. Polyesters

Suitable polyesters are known per se and are described in the literature. Their main chain contains an aromatic ring derived from an aromatic dicarboxylic acid. The aromatic ring may also have substitution, for example by halogen, such as chlorine or bromine, or by C₁-C₄-alkyl, such as methyl, ethyl, isopropyl, n-propyl, n-butyl, isobutyl, or tert-butyl.

The polyesters may be prepared by reacting aromatic dicarboxylic acids, or their esters, or other ester-forming -derivatives of the same, with aliphatic dihydroxy compounds, in a manner known per se.

Preferred dicarboxylic acids are naphthalenedicarboxylic acid, terephthalic acid, and isophthalic acid, and mixtures of these. Up to 10 mol % of the aromatic dicarboxylic acids may be replaced by aliphatic or cycloaliphatic dicarboxylic acids, such as adipic acid, azelaic acid, sebacic acid, dodecanedioic acids, or cyclohexanedicarboxylic acids. Among the aliphatic dihydroxy compounds, preference is given to diols having from 2 to 6 carbon atoms, in particular 1,2-ethanediol, 1,4-butanediol, 1,6-hexanediol, 1,4-hexanediol, 1,4-cyclohexanediol, and neopentyl glycol, or a mixture of these.

Particularly preferred polyesters are polyalkylene terephthalates derived from alkanediols having from 2 to 6 carbon atoms. Among these, particular preference is given to polyethylene terephthalate (PET), polyethylene naphthalate, and polybutylene terephthalate (PBT).

The viscosity number of the polyesters is generally in the range from 60 to 200 ml/g, measured in a 0.5% strength by weight solution in a phenol/o-dichlorobenzene mixture (ratio by weight: 1:1)at 25° C.

The polymers B mentioned under 1. and 2. may be used on their own or in a mixture with one another.

However, the polymers B mentioned under 1. and 2. may also be used in a mixture with the polymers 3. and 4. mentioned below. The polymers mentioned under 3. and 4. therefore also count as component B, but are used together with at least one of the polymers B mentioned under 1. and 2.

3. Polycarbonates (PC)

Suitable polycarbonates are known per se. They can be attained by the process of DE-B-1 300 266 by interfacial polycondensation, for example, or by the process of DE-A-14 95 730 by reacting diphenyl carbonate with bisphenols. The preferred bisphenol is 2,2-di(4-hydroxyphenyl)propane, generally and hereinafter termed bisphenol A.

Use may also be made of other aromatic dihydroxy compounds instead of bisphenol A, in particular 2,2-di(4-hydroxyphenyl)pentane, 2,6-dihydroxynaphthalene, 4,4′-dihydroxydiphenyl sulfone, 4,4′-dihydroxydiphenyl ether, 4,4′-dihydroxydiphenyl sulfite, 4,4′-dihydroxydiphenylmethane, 1,1-di(4-hydroxyphenyl)ethane, or 4,4-dihydroxybiphenyl, or else a mixture of the abovementioned dihydroxy compounds.

Particularly preferred polycarbonates are those based on bisphenol A or bisphenol A together with up to 30 mol % of the abovementioned aromatic dihydroxy compounds.

The relative viscosity of these polycarbonates is generally in the range from 1.1 to 1.5, in particular from 1.28 to 1.4 (measured at 25° C. in a 0.5% strength by weight solution in dichloromethane).

4. Polyamides (PA)

Suitable polyamides are those having an aliphatic and semicrystalline or semiaromatic, or else amorphous structure of any type, and blends of these, including polyetheramides, such as polyether block amides.

For the purposes of the present invention, polyamides are all known polyamides.

These polyamides generally have a viscosity number of from 90 to 350 ml/g, preferably from 110 to 240 ml/g, determined on a 0.5% strength by weight solution in 96% strength by weight sulfuric acid at 25° C. to ISO 307.

Preference is given to semicrystalline or amorphous resins with a molecular weight (weight-average) of at least 5000, as described, for example, in U.S. Pat. Nos. 2,071,250, 2,071,251, 2,130,523, 2,130,948, 2,241,322, 2,312,966, 2,512,606 and 3,393,210. Examples of these are polyamides derived from lactams having from 7 to 13 ring members, for example polycaprolactam, polycaprylolactam, and polylaurolactam, and polyamides obtained by reacting dicarboxylic acids with diamines.

Dicarboxylic acids which may be employed are alkanedicarboxylic acids having from 6 to 12 carbon atoms, in particular from 6 to 10 carbon atoms, and aromatic dicarboxylic acids. Merely as examples, mention may be made of adipic acid, azelaic acid, sebacic acid, dodecanedioic acid (decanedicarboxylic acid), and terephthalic and/or isophthalic acid. Particularly suitable diamines are alkanediamines having from 6 to 12 carbon atoms, in particular from 6 to 8 carbon atoms, and m-xylylenediamine, di(4-aminophenyl)methane, di(4-aminocyclohexyl)methane, 2,2-di(4-aminophenyl)propane, and 2,2-di(4-aminocyclohexyl)propane.

Preferred polyamides are polyhexamethyleneadipamide (nylon-6,6) and polyhexamethylenesebacamide (nylon-6,10), polycaprolactam (nylon-6), and also the copolyamides nylon-6/6,6, in particular with a proportion of from 5 to 95% by weight of caprolactam units. Particular preference is given to nylon-6, nylon-6,6, and the copolyamides nylon-6/6,6.

Besides these, mention should also be made of polyamides obtainable, for example, by condensing 1,4-diaminobutane with adipic acid at an elevated temperature (nylon-4,6). Preparation processes for polyamides of this structure are described in EP-A 38 094, EP-A 38 582 and EP-A 39 524, for example.

Other examples of polyamides are those obtainable by copolymerizing two or more of the abovementioned monomers, and mixtures of two or more polyamides in any desired mixing ratio.

Other polyamides which have proven especially advantageous (see EP-A 299 444) are semiaromatic copolyamides, such as nylon-6/6,T and nylon-6,6/6,T, having a triamine content which is below 0.5% by weight, preferably below 0.3% by weight. The semiaromatic copolyamides having low triamine content may be prepared by the processes described in EP-A 129 195 and EP-A 129 196.

The list below, which is not comprehensive, includes the polyamides mentioned and also other suitable polyamides (followed by mention of the monomers):

| | |
|---|---|
| nylon-4,6 | tetramethylenediamine, adipic acid |
| nylon-6,6 | hexamethylenediamine, adipic acid |
| nylon-6,9 | hexamethylenediamine, azelaic acid |
| nylon-6,10 | hexamethylenediamine, sebacic acid |
| nylon-6,12 | hexamethylenediamine, decanedicarboxylic acid |
| nylon-6,13 | hexamethylenediamine, undecanedicarboxylic |
| | acid |
| nylon-12,12 | 1,12-dodecanediamine, decanedicarboxylic acid |
| nylon-13,13 | 1,13-diaminotridecane, undecanedicarboxylic |
| | acid |
| nylon MXD,6 | m-xylylenediamine, adipic acid |
| nylon TMD,T | trimethylhexamethylenediamine, terephthalic |
| | acid |
| nylon-4 | pyrrolidone |
| nylon-6 | ε-caprolactam |
| nylon-7 | ethanolactam |
| nylon-8 | caprylolactam |
| nylon-9 | 9-aminopelargonic acid |
| nylon-11 | 11-aminoundecanoic acid |
| nylon-12 | laurolactam |

These polyamides and their preparation are known. The person skilled in the art may find details of their preparation in Ullmanns Encyklopadie der Technischen Chemie, 4th edition, Vol. 19, pp. 39-54, Verlag Chemie, Weinheim 1980, and Ullmanns Encyclopedia of Industrial Chemistry, Vol. A21, pp. 179-206, VCH Verlag, Weinheim 1992, and Stoeckhert, Kunststofflexikon, 8 th edition, pp. 425-428, Hanser Verlag Munich 1992 (keyword Polyamide and those following).

Preferred Products of the Process, Additives

The product of the process of the invention, i.e. the rubber-containing thermoplastic molding composition made from components A and B, therefore preferably comprises from 5 to 80% by weight, in particular from 10 to 60% by weight, and particularly preferably from 15 to 50% by weight, of elastomeric polymers A, and from 20 to 95% by weight, in particular from 40 to 90% by weight, and particularly preferably from 50 to 85% by weight, of thermoplastic polymers B, based in each case on the rubber-containing thermoplastic molding composition.

The product of the process of the invention, i.e. the rubber-containing thermoplastic molding composition made from components A and B, is particularly preferably an acrylonitrile-butadiene-styrene polymer (ABS), an acrylonitrile-styrene-acrylate polymer (ASA), a methyl methacrylate acrylonitrile-butadiene-styrene polymer (MABS), or an acrylonitrile-(ethylene-propylene)-styrene polymer (AES).

The proportion of the elastomeric polymer A (e.g. diene graft rubber, acrylate graft rubber, acrylate graft rubber, EPM graft rubber or EPDM graft rubber) in the abovementioned ABS, ASA, MABS, or AES molding compositions is preferably from 5 to 80% by weight, in particular from 10 to 60% by weight, and very particularly preferably from 15 to 50% by weight, based on the rubber-containing thermoplastic molding composition. The proportion of the thermoplastic polymer B (e.g. SAN or PMMA) is preferably from 20 to 95% by weight, in particular from 40 to 90% by weight, and very particularly preferably from 50 to 85% by weight, based on the rubber-containing thermoplastic molding composition.

In addition to components A and B, the rubber-containing thermoplastic molding compositions may comprise additives as component C. The proportion present of the additives C in the thermoplastic molding compositions is preferably from 0 to 50% by weight, particularly preferably from 0.1 to 45% by weight, and very particularly preferably from 0.2 to 30% by weight, based on the entirety of the components A to C.

Component C encompasses lubricants, mold-release agents, waxes, colorants (pigments, dyes), flame retardants, antioxidants, light stabilizers, fibrous and pulverulent fillers, fibrous and pulverulent reinforcing materials, and antistatic agents, and also other additives, and mixtures of these.

Examples of suitable lubricants and mold-release agents are stearic acids, stearyl alcohol, stearic esters, stearamides, and also silicone oils, montan waxes, and those based on polyethylene or polypropylene.

Examples of pigments are titanium dioxide, phthalocyanines, ultramarine blue, iron oxides, and carbon black, and the entire class of organic pigments. For the purposes of the present invention, dyes are any of the dyes which can be used for the transparent, semitransparent, or non-transparent coloring of polymers, in particular those dyes which are suitable for coloring styrene copolymers or for coloring MMA homo- or copolymers. Dyes of this type are known to the person skilled in the art.

Examples of flame retardants which may be used are the halogen-containing or phosphorus-containing compounds known to the person skilled in the art, magnesium hydroxide, and also other commonly used compounds, and mixtures of these. Red phosphorus is also suitable.

Suitable antioxidants are in particular sterically hindered mononuclear or polynuclear phenolic antioxidants, which may have various substituents and may also have bridging by substituents. These include monomeric and oligomeric compounds, which may have been built up from two or more phenolic building blocks. It is also possible to use hydroquinones or hydroquinone analogs, or substituted compounds, or else antioxidants based on tocopherols or on derivatives of these. It is also possible to use mixtures of various antioxidants. In principle, use may be made of any compounds which are commercially available or are suitable for styrene copolymers, for example Topanol®, Irganox®, Lowinox®, or Ralox®.

Together with the phenolic antioxidants mentioned above by way of example, concomitant use may be made of what are known as costabilizers, in particular phosphorus- or sulfur-containing costabilizers. These P- or S-containing costabilizers are known to the person skilled in the art and are available commercially.

Examples of suitable stabilizers to counter the effect of light are various substituted resorcinols, salicylates, benzotriazoles, benzophenones, and HALS (hindered amine light stabilizers), for example those commercially available as Tinuvin® (Ciba) or Uvinul® (BASF).

Examples of fibrous or pulverulent fillers are carbon fibers and glass fibers in the form of glass wovens, glass mats, or glass silk rovings, chopped glass, glass beads, and also wollastonite, particularly preferably glass fibers. When glass fibers are used, these may have been provided with a size and with a coupling agent to improve compatibility with the components of the blend. The glass fibers incorporated may either be in the form of short glass fibers or else in the form of continuous strands (rovings).

Suitable particulate fillers are carbon black, amorphous silica, magnesium carbonate, chalk, powdered quartz, mica, bentonite, talc, feldspar, and in particular calcium silicates, such as wollastonite, and kaolin.

Examples of suitable antistatic agents are amine derivatives, such as N,N-bis(hydroxyalkyl)alkylamines or -alkyleneamines, polyethylene glycol esters, copolymers of ethylene glycol and propylene glycol, and glycerol mono- and distearates, and also mixtures of these.

The amounts used of each additive C are those which are usual, and further details in this connection are therefore superfluous.

The entirety of components A, B, and, if present, C is of course 100% by weight.

The Process

The process of the invention prepares components A and B by polymerizing the appropriate monomers, component A being present as a dispersion in an aqueous phase after the polymerization. The finished polymers A and B are mixed with one another. It is important for the invention that at least one pH buffer system is added to the aqueous phase once the polymerization of component A has ended.

As described in more detail below, for the purposes of the present invention “pH buffer system” may also imply that just one component of the buffer is added and that the second component of the buffer forms within the aqueous phase.

Preferred pH buffer systems are those which in aqueous solution set the pH (at 25° C.) at from 1 to 12, preferably from 3 to 12, and in particular from 5 to 12. pH buffer systems of this type, referred to below by the abbreviated term buffer I, are known to the person skilled in the art and are generally composed of a proton donor (Brönsted acid) and proton acceptor (Brönsted base).

These buffers I may be identical with the buffers II which were mentioned above for component A and which may be present as additives during the preparation of component A by emulsion polymerization. However, the buffers II mentioned at that point and the buffers I used here may also differ from one another.

The buffers I may be composed of inorganic compounds, e.g. dihydrogenphosphate/hydrogenphosphate, or of organic compounds, e.g. barbital/sodium salt of barbital, or of inorganic and organic compounds. Suitable buffers I are often composed of a weak acid and a dissociated neutral salt of the same acid, e.g. acetic acid/sodium acetate. However, other suitable buffers I are composed of a dissociated neutral salt of a weak base and this weak base, e.g. ammonium chloride/ammonia. The acid and the base do not have to come from the same compound, and buffers I such as barbital/sodium acetate are therefore also suitable.

Zwitterion buffers are also suitable. They comprise secondary and tertiary amino groups as proton donors and sulfonic acid or carboxy groups as proton acceptors, examples being ACES buffer (2-[(carbamoylmethylaminoethanesulfonic acid) and TES buffer (2-{[tris(hydroxymethyl)methylaminoethanesulfonic acid).

Preferred buffers I are those selected from barbital/sodium salt of barbital, barbital/sodium acetate, and particularly preferably hydrogencarbonate/carbonate, citric acid/citrate, acetic acid/acetate, hydrogenphosphate/phosphate, dihydrogenphosphate/hydrogenphosphate, boric acid/borate, ammonium/ammonia, citrate/borax, phthalate/alkali metal hydroxide, phthalate/hydrbchloric acid, citrate/alkali metal hydroxide, citric acid/hydrogenphosphate, and mixtures of these.

In one preferred embodiment, the counterions for the ions mentioned are selected in such a way that the salt composed of cations and anions is water-soluble. Water-soluble means here that the form in which the salt is present in water at from 25 to 80° C. is entirely or mainly the dissolved form.

Examples of counter-cations suitable for good water-solubility are ammonium and alkali metal cations, such as sodium and potassium. Sodium and potassium are particularly preferred counter-cations. Examples of suitable counter-anions (for ammonium) are halide anions, such as fluoride, chloride, and bromide, and anions of strong acids, for example nitrate and sulfate. Chloride is a preferred counter-anion. If both buffer solutions are ionic, as is the case with the buffers hydrogenphosphate/phosphate and dihydrogenphosphate/hydrogenphosphate, the counterions may be identical (e.g. disodium hydrogenphosphate/trisodium phosphate) or different (e.g. potassium dihydrogenphosphate/disodium hydrogenphosphate).

Hydrogencarbonate/carbonate buffer, which also has the outmoded name bicarbonate buffer, is particularly preferred as buffer I. It is often sufficient here for just one component of the buffer to be added, since the other component forms by protonation or deprotonation in the acidic or basic aqueous phase in which the polymer A is present (see explanation further below). Suitable hydrogencarbonates and, respectively, carbonates are those of sodium, of potassium, and of ammonium. Very particular preference is given to the use of sodium hydrogencarbonate/sodium carbonate buffer.

The buffers I may be prepared by combining the proton donor and the proton acceptor. The buffers I may also be prepared by adding less than an equimolar amount of a strong acid (base) to the proton acceptor (proton donor), the result being that this is protonated (deprotonated) and therefore becomes a proton donor (proton acceptor). For example, acetic acid/acetate buffer may be prepared either by combining acetic acid and sodium acetate or by adding less than an equimolar amount of hydrochloric acid to sodium acetate, or adding sodium acetate to an acidic solution, the result being that some of the acetate is converted into acetic acid, or by adding less than an equimolar amount of sodium hydroxide to acetic acid, or adding acetic acid to a basic solution, the result being that some of the acetic acid is converted into acetate.

A method which can be used in many cases for preparing the buffers I and which is particularly preferred because it is easy to carry out consists in adding only one of the components of the buffers (either the proton donor or the proton acceptor) to the aqueous dispersion of component A. The proton content (pH) of the dispersion causes some of the component of the buffers to be protonated or deprotonated, the result being establishment of the buffer equilibrium. For example, sodium hydrogencarbonate may be added to a basic aqueous dispersion of A, the dispersion having a pH of from 8 to 10. Some of the hydrogencarbonate deprotonates to give carbonate in the basic dispersion, and the hydrogencarbonate/carbonate buffer is produced.

The wording “adding a pH buffer system” in the claims may therefore also imply that only one component of the buffer is added, and that the second component of the buffer forms within the aqueous phase. Very particular preference is given to this embodiment.

It is also possible, of course, to use mixtures of various buffers I. In this case, the quantity data below are based on the total amount of all of the buffers I.

The amount used of the buffer I (entirety of proton donor and proton acceptor) is generally from 0.01 to 5% by weight, preferably from 0.05 to 4% by weight, and particularly preferably from 0.08 to 3% by weight, based on component A. Component A here means solid, i.e. pure A without the water of the dispersion and without any adhering or enclosed water.

The buffer I may be added at any desired juncture as long as this juncture is subsequent to the ending of the polymerization of component A and prior to complete removal of the aqueous phase.

For the purposes of the present invention, “the ending of the polymerization” implies that at least 95% by weight of the graft monomers have reacted.

At the juncture of addition of the buffer I, at least some of the aqueous phase must still be present. Depending on the solubility of the buffer in water, the residual water adhering to or enclosed in a moist elastomeric polymer A may itself be sufficient, i.e. the polymer A need not be “suspended” in the aqueous phase, and a moist polymer A may itself comprise sufficient aqueous phase for a readily soluble buffer I.

The buffer I may be added undiluted or dissolved or dispersed in a diluent, such as water, or in a mixture of water and organic solvents, such as alcohols. In this last case, the solvent is in turn removed, e.g. by evaporation or degassing, during the mixing process or in an upstream or downstream step.

According to the invention, the buffer I is added to a component A which is in dispersion in an aqueous phase, or is at least still moist. Components A of this type are in particular the graft rubbers (graft polymers) described above composed of diene rubbers, of acrylate rubbers, of EPM rubbers, or of EPDM rubbers, or of silicone rubbers, as long as the rubbers are prepared in an aqueous phase, i.e. in particular by emulsion polymerization, suspension polymerization, or the mini or micro variants of these. For this embodiment preference is given to buffers I with good water-solubility.

One way of adding the buffer I is prior to coagulation of the rubber. This is very particularly preferred. One preferred embodiment of the process therefore comprises adding the buffer I prior to coagulation of the elastomeric polymer A.

Addition may also take place during coagulation. In this case, coagulant and buffer I are added simultaneously. This is also very particularly preferred.

The buffer I may also be added after coagulation of the rubber, for example during the removal, as described above, of the aqueous phase from the rubber. In particular, the buffer I may be added to the water used for washing the coagulated rubber.

The mixing of components A and B takes place in a conventional manner known per se, for example by extruding, kneading, or roll-milling these together, components A and B having been isolated, if necessary, in advance from the solution obtained during the polymerization or from the aqueous dispersion.

If component A or B is incorporated in the form of an aqueous dispersion or of an aqueous or non-aqueous solution, the water or the solvent is removed from the mixing apparatus, preferably an extruder, via a devolatilizing unit.

Examples of mixing apparatuses for mixing A and B are discontinuously operating heated internal mixers with or without rams, continuously operating kneaders, such as continuous internal mixers, screw compounders having axially oscillating screws, Banbury mixers, and also extruders, roll mills, mixing rolls where the rolls are heated, and calenders.

Preference is given to using an extruder as mixing apparatus. Single- or twin-screw extruders, for example, are particularly suitable for extruding the melt. A twin-screw extruder is preferred.

In some cases, the mechanical energy introduced by the mixing apparatus during the mixing process is sufficient to bring about melting of the mixture, and it is therefore not necessary to heat the mixing apparatus. Otherwise, the mixing apparatus is generally heated. The temperature depends on the chemical and physical properties of components A and B and has to be such that sufficient mixing of A and B takes place. However, the temperature should not be excessive, otherwise thermal degradation of the polymer mixture may occur. It may also be that the mechanical energy introduced is sufficiently great to require cooling of the mixing apparatus. The temperature at which the mixing apparatus is generally operated is from 150 to 300° C., preferably from 180 to 300° C.

In one preferred embodiment, the graft polymer A is mixed with the polymer B in an extruder, the dispersion of the graft polymer A being metered directly into the extruder without prior removal of the water of the dispersion. The water is usually removed over the length of the extruder via suitable devolatilizing systems. Examples of devolatilization systems which may be used are vents which may be provided with retaining screws (which prevent the emergence of the polymer mixture).

In another embodiment, which is likewise preferred and is a process for incorporating moist material, the graft polymer A is mixed with the polymer B in an extruder, the graft polymer A having been isolated in advance from the water of the dispersion. This prior removal of the water of the dispersion gives moist graft polymers A with a residual water content of up to 60% by weight, based on A, where this residual water may either adhere externally to the graft polymer or else have been enclosed therein, for example. The residual water present may then be removed as described above as vapor via devolatilizing systems on the extruder.

In one particularly preferred embodiment which is a process for incorporating moist material, however, the residual water in the extruder is not removed solely as vapor, but some of the residual water is removed mechanically within the extruder and leaves the extruder in the liquid phase. This specific process for incorporating moist material is described in more detail below:

The graft polymer is first separated from the water of the dispersion, for example by sifting, pressing, filtering, decanting, sedimenting, or centrifuging, or by drying with some involvement of heat. The graft polymer from which water has been partially removed in this way, and which comprises up to 60% by weight of residual water, is then metered into the extruder. The material metered in is conveyed by the screw against a retarding element which acts as an obstacle and is generally located at the end of a “squeeze section”. This restricted flow zone builds up a pressure which presses (“squeezes”) the water out of the graft polymer. Various pressures may be built up, depending on the rheological behavior of the rubber, by varying the arrangement of screw elements, kneading elements, or other retarding elements. In principle, any commercially available element which serves to build up pressure in the apparatus is suitable.

Examples of possible retarding elements are pushed-over, conveying screw elements, screw elements having a pitch opposite to the conveying direction (preferred), including screw elements having conveying threads of large pitch (pitch larger than the diameter of the screw) opposite to the conveying direction (termed LGS elements), kneading blocks having non-conveying kneading disks of different widths, kneading blocks having a back-conveying pitch (preferred), kneading blocks having a conveying pitch, barrel disks, eccentric disks, and blocks configured therefrom, neutral retarding disks (baffles), mechanically adjustable restrictors (sliding barrels, radial restrictors, central restrictors). It is also possible to combine two or more of the retarding elements with one another. The retarding action of the retarding zone may also be adapted to the respective graft rubber, via the length and the intensity of the individual retarding elements.

The water pressed out of the graft polymer in the squeeze section leaves the extruder entirely or mainly in the liquid phase, and not as vapor. The squeeze section has one or more water-removal orifices, which are normally under atmospheric or superatmospheric pressure. The dewatering orifices preferably have an apparatus which prevents the emergence of the graft polymer A which is being conveyed. Retaining screws are particularly preferred for this purpose. In one particularly preferred embodiment, the water-removal orifices used are not Seiher housings or similar components which block rapidly, for example sieves, but rather are recesses or holes in the extruder barrel.

In one preferred embodiment, the feed sections and the squeeze sections of the extruder are not heated. In one embodiment, these particular sections of the extruder are cooled.

The graft polymer A from which the water has been pressed out is conveyed through the retarding zones and passes into the next section of the extruder. This may be another squeeze section, for example, or a section for incorporating component B, or a devolatilizing section.

The removal of the residual water from component A and the mixing with component B very particularly preferably take place in the same extruder. To this end, it is preferable for the water first to be removed mechanically as described by pressing the rubber A in the ingoing part of the extruder, followed by incorporation of component B, preferably a melt of B, in the middle of the extruder, and mixing of A and B at the end of the extruder, followed by discharge.

The temperatures to be selected in a particular case by way of cooling or heating, and the lengths of each of the sections, depend on the chemical and physical properties of components A and B and on their quantitative proportions. The same applies to the screw rotation rate, which may vary over a wide range. Merely by way of example, mention may be made of extruder screw rotation rates in the range from 100 to 350 rpm.

Details of the mixing of components A and B in the same extruder, and of the process for incorporating moist material, can be found in WO-A 99/01489 and WO-A 98/13412.

If the buffer I is added during the mixing of components A and B in an extruder, it may be incorporated at one or more locations on the extruder.

Irrespective of the mixing apparatus used and of the juncture at which addition takes place, the following applies: the buffer I may be added batchwise all at once, for example, or batchwise at various junctures after division into two or more portions, or continuously over a particular period of time. Continuous addition may also follow a gradient, e.g. rising or falling, linear or exponential, staged (step function) or obeying any other mathematical function.

It is also possible, for example, for a portion of the buffer I to be added to the dispersion of component A prior to coagulation and for another portion to be added to the extruder during the process for incorporating moist material.

If two or more buffers I are used, they may be added simultaneously or at different times. The two paragraphs above apply similarly.

The addition of the buffer I generally takes place by way of conventional metering apparatuses, as a solid, e.g. via vibration chutes, metering screws, helical conveyors, or metering belts, or liquid, e.g. via pumps or by gravity.

Use of the Molding Compositions

The rubber-containing thermoplastic molding compositions obtainable by the process of the invention may be processed by the known methods of thermoplastics processing, i.e. by extrusion, injection molding, calendering, blow molding, compression molding, or sintering.

The molding compositions may be used to produce moldings, films, fibers, or foams of any type. In particular, the molding compositions may be used to produce injection moldings, with a marked reduction in the formation of deposit on the moldings and in the injection mold.

The invention therefore also provides a process for reducing mold deposit during the production of injection moldings from rubber-containing thermoplastic molding compositions, wherein the rubber-containing thermoplastic molding compositions of the invention are used for injection molding.

The molding compositions of the invention cause considerably less formation of mold deposits. The amount of deposits formed on molds during injection molding or extrusion is markedly smaller than in the processes of the prior art, in particular much smaller than with the addition of magnesium oxide. There is a marked reduction in the amount of machine-stoppage time required for removing the mold deposit, i.e. there is a substantially less frequent requirement for cleaning shutdowns. The moldings produced from the molding compositions have better quality and no problematic deposits.

### EXAMPLES

1. Preparation of an Elastomeric Graft Polymer A

1.1. Preparation of Graft Base a1)

43120 g of butadiene were polymerized at 65° C. in the presence of 432 g of tert-dodecyl mercaptan (TDM), 311 g of the potassium salt of C₁₂-C₂₀ fatty acids, 82 g of potassium persulfate, 147 g of sodium hydrogencarbonate, and 58,400 g of water, to give a polybutadiene latex. The details of the procedure were as described in EP-A 62901, Ex. 1, p. 9, line 20-p. 10, line 6, the TDM being added in a number of portions. The conversion was 95%. The median particle size d₅₀ of the latex was 100 nm.

35,000 g of the resultant latex were agglomerated at 65° C. by adding 2700 g of a dispersion (solids content 10% by weight) made from 96% by weight of ethyl acrylate and 4% by weight of methacrylamide (partial agglomeration).

1.2. Preparation of Graft a2)

9000 g of water, 130 g of the potassium salt of C₁₂-C₂₀ fatty acids, and 17 g of potassium peroxodisulfate were added to the agglomerated latex. 9500 g of a mixture made from 80% by weight of styrene and 20% by weight of acrylonitrile were then added at 75° C. within a period of 4 hours, with stirring. The conversion, based on the graft monomers, was almost quantitative.

The resultant graft polymer dispersion with bimodal particle size distribution had a median particle size d₅₀ of 140 nm and a d₉₀ of 420 nm. There was a first maximum of the particle size distribution in the range from 50 to 150 nm and a second maximum in the range from 200 to 600 nm.

The dispersion obtained was mixed with an aqueous dispersion of an antioxidant.

1.3. Addition of pH Buffer System and Work-up of Dispersion

Solid sodium hydrogencarbonate was added to the basic dispersion (pH about 8.8) obtained in 1.2. The concentration of the buffer was 0.1% by weight, based on the graft rubber A as dry solid (without the water of the dispersion).

The rubber dispersion was then coagulated by adding a magnesium sulfate solution. The coagulated rubber was centrifuged to remove the water of the dispersion, and washed with water. This gave a graft rubber A with about 30% by weight of adhering or enclosed residual-water.

2. Preparation of a Thermoplastic Polymer B (Hard Matrix)

A thermoplastic polymer was prepared from 76% by weight of styrene and 24% by weight of acrylonitrile, by continuous solution polymerization, as described in Kunststoff-Handbuch, Ed. R. Vieweg and G. Daumiller, Vol. V “Polystyrol”, Carl-Hanser-Verlag Munich 1969, pp. 122-124. The viscosity number VN was 67 ml/g, determined to DIN 53 726 at 25° C. on a 0.5% strength by weight solution in dimethylformamide. This corresponded to a weight-average molar mass of about 150,000 g/mol.

3. Blending of Components A and B and Investigation of Mold Deposit Formation

The graft rubber A comprising residual water was metered in a Werner and Pfleiderer ZSK 40 extruder, the front part of whose two conveying screws had been provided with restrictors which build up pressure. A considerable part of the residual water was pressed out mechanically in this manner and left the extruder in liquid form via dewatering orifices. The hard matrix B was introduced to the extruder downstream beyond the restrictor zones, and intimately mixed with the dewatered component A. The remaining residual water was removed via vents in the rear portion of the extruder in the form of vapor. The extruder was operated at 250 rpm with a throughput of 80 kg/h. The amounts selected of A and B were such that the molding composition comprised 30% by weight of graft rubber A. The molding composition was extruded, and the solidified molding composition was pelletized.

Housing parts for an electronic component were produced from the pellets on an Aarburg allrounder injection molding machine at 250° C. melt temperature and 60° C. mold surface temperature. The mold used for this had intensive cooling. The shot weight (weight of the polymer injected for each injection molding procedure) was about 47 g and an average of 3 casing parts were produced per minute. Each casing part was assessed visually for surface quality.

As soon as the surface quality became inadequate, the injection molding machine was shut down for cleaning. The period of time until this cleaning shutdown served as a measure of mold-deposit formation: the longer the period to the first cleaning shut down, the smaller the amount of mold deposit formed.

4. Non-inventive Comparative Examples

Example 1c: Omission of pH Buffer System

The example above was repeated, except that no pH buffer system was added in step 1.3 prior to coagulation.

Example 2c: Magnesium Oxide for Reducing Mold Deposit

Comparative Example 1c was repeated, except that during the blending of components A and B (step 3 above) 0.15% by weight of magnesium oxide was added, based on the entirety of A and B.

5. Results of Tests

The table gives the results.

| | Period until first cleaning |
|---|---|
| Molding composition | shut down [min] |
| According to the invention with | 3600 |
| pH buffer | |
| Comparative Ex. 1c without pH | 15 |
| buffer | |
| Comparative Ex. 2c without pH | 50 |
| buffer and with magnesium oxide | |

If, not according to the invention, no pH buffer is added to the molding compositions, the first cleaning shutdown of the machine is required after as little as 15 min.

If, again not according to the invention, magnesium oxide is added to the molding compositions instead of the pH buffer, this period extends to 50 min, i.e. increases by a factor of about three.

In contrast, the process of the invention gives molding compositions which do not require any cleaning shutdown of the machine for removing mold deposit until 3600 min (=60 hours) have passed. This period is 240 times longer than in Comparative Example 1c and 72 times longer than. in Comparative Example 2c.

The mold-deposit-reducing effect is therefore substantially more marked in the process of the invention than in the processes of the prior art.

We claim:

1. A process for preparing rubber-containing thermoplastic molding compositions, by using polymerization to prepare at least one elastomeric polymer A and at least one thermoplastic polymer B, and mixing these with one another, the elastomeric polymer A being present in dispersed form in an aqueous phase after the polymerization,
which comprises adding at least one pH-buffer system to the aqueous phase after the polymerization of component A has ended.

2. A process as claimed in claim 1, wherein the elastomeric polymer A has been selected from diene rubbers, acrylate rubbers, rubbers based on ethylene and propylene, and silicone rubbers, and mixtures of these.

3. A process as claimed in claim 1 or 2, wherein the elastomeric polymer A is a graft rubber comprising at least one elastomeric graft base with a glass transition temperature Tg of 0° C. or below and at least one hard graft with a glass transition temperature Tg above 25° C.

4. A process as claimed in any of claims 1 to 3, wherein the thermoplastic polymer B has been selected from vinylaromatic polymers, polymers based on methyl methacrylate, polyesters, polymers based on imides, and mixtures of these.

5. A process as claimed in any of claims 1 to 4, wherein the rubber-containing thermoplastic molding composition is an acrylonitrile-butadiene-styrene polymer (ABS), an acrylonitrile-styrene-acrylate polymer (ASA), a methyl methacrylate-acrylonitrile-butadiene-styrene polymer (MABS), or an acrylonitrile-(ethylene-propylene)-styrene polymer (AES).

6. A process as claimed in any of claims 1 to 5, wherein the pH-buffer system has been selected from the following buffers: hydrogencarbonate/carbonate, citric acid/citrate, acetic acid/acetate, hydrogenphosphate/phosphate, dihydrogenphosphate/hydrogenphosphate, boric acid/borate, ammonium/ammonia, citrate/borax, phthalate/alkali metal hydroxide, phthalate/hydrochloric acid, citrate/alkali metal hydroxide, citric acid/hydrogenphosphate, and mixtures of these.

7. A process as claimed in any of claims 1 to 6, wherein the pH buffer system is sodium hydrogencarbonate/sodium carbonate.

8. A process as claimed in any of claims 1 to 7, wherein the pH buffer system is added prior to coagulation of the elastomeric polymer A.

9. A rubber-containing thermoplastic molding composition obtainable by the process as claimed in any of claims 1 to 8.

10. The use of the rubber-containing thermoplastic molding composition as claimed in claim 9 for producing moldings, films, fibers, or foams.

11. The use as claimed in claim 10, where the moldings are injection moldings.

12. A molding, a film, a fiber, or a foam made from the rubber-containing thermoplastic molding compositions as claimed in claim 9.

13. A process for reducing mold deposit in the production of injection moldings from rubber-containing thermoplastic molding compositions, which comprises using the rubber-containing thermoplastic molding compositions as claimed in claim 9 for injection molding.
